(19) United States
(12) Patent Application Publication
(10) Pub. No.: US 2009/0294302 A1
(43) Pub. Date: Dec. 3, 2009

(54) Use of Alginate to Reduce Hematocrit Bias in Biosensors

(76) Inventors: John Pasqua, Wellington, FL (US); Angela Carlson, Lake Worth, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/127,933

(22) Filed: May 28, 2008

(51) Int. Cl. G01N 27/26

(52) U.S. Cl. 205/777.5; 204/403.01

(57) ABSTRACT

Methods and devices for determining the concentration of a constituent in a body sample are provided. The body sample is introduced into a biosensor having a sample chamber and at least part of an electrode disposed therein. The biosensor also includes an alginate hydrogel substantially covering a portion of the sample chamber. The alginate hydrogel substantially includes an alginate polymer configured to reduce cellular migration.

### FIELD OF THE INVENTION

The present invention relates to the field of diagnostic body sample measurement and, more particularly, to biosensors and methods using alginate to reduce hematocrit bias.

### BACKGROUND OF THE INVENTION

Many industries have a commercial need to monitor the concentration of particular constituents in a fluid. The oil refining industry, wineries, and the dairy industry are examples of industries where fluid testing is routine. In the health care field, people such as diabetics, for example, need to monitor various constituents within their bodily fluids using biosensors. A number of systems are available that allow people to test a body fluid (e.g. blood, urine, or saliva), to conveniently monitor the level of a particular fluid constituent, such as, for example, cholesterol, proteins, or glucose.

Electrochemical sensors have long been used to detect or measure the presence of substances in a fluid sample. Electrochemical sensors typically include a reagent mixture containing at least an electron transfer agent (also referred to as an “electron mediator”), an analyte specific bio-catalytic protein (e.g., a specific enzyme), and one or more electrodes. Such sensors rely on electron transfer between the electron mediator and the sensor's electrodes to measure electrochemical redox reactions. Electron transfer reactions typically produce an electrical signal that correlates to the concentration of the analyte being measured in the fluid sample.

The use of such electrochemical sensors to detect analytes in bodily fluids, such as blood or blood derived products, has become important, and in some cases, vital to maintain the health of certain individuals. In the health care field, people such as diabetics, for example, have a need to monitor a particular constituent within their bodily fluids. A number of systems are available that allow people to test a body fluid, such as, blood, urine, or saliva, to conveniently monitor the level of a particular fluid constituent, such as, for example, cholesterol, proteins, and glucose. Patients suffering from diabetes, a disorder of the pancreas where insufficient insulin production reduces the body's ability to process sugar, have a need to carefully monitor their blood glucose levels on a daily basis. Routine testing and controlling blood glucose for people with diabetes can reduce their risk of serious damage to the eyes, nerves, and kidneys.

A number of systems permit people to conveniently monitor their blood glucose levels, and such systems typically include a test strip where the user applies a body sample and a meter that “reads” the test strip to determine the glucose level in the blood sample. An exemplary electrochemical biosensor is described in U.S. Pat. No. 6,743,635 ('635 patent), which is incorporated by reference herein in its entirety. The '635 patent describes an electrochemical biosensor used to measure a glucose level in a blood sample. The electrochemical biosensor system can include a test strip and a meter. The test strip can include a sample chamber, a working electrode, a counter electrode, and one or more fill-detect electrodes. A reagent layer can also be disposed in the sample chamber. The reagent layer can contain an enzyme specific for glucose, such as, glucose oxidase, and a mediator, such as, potassium ferricyanide. When a user applies a blood sample to the sample chamber on the test strip, the reagents react with the glucose in the blood sample and the meter applies a voltage to the electrodes to cause a redox reaction. The meter then measures the resulting current that flows between the working and counter electrodes and calculates the glucose level based on the current measurements.

Biosensors configured to measure a blood constituent concentration may be affected by the presence of certain blood components that may undesirably affect the measurement and lead to inaccuracies in the detected signal. This inaccuracy may result in an inaccurate glucose reading, leaving the patient unaware of a potentially dangerous blood sugar level. As one example, the particular blood hematocrit level (i.e., the percentage of blood occupied by red blood cells) can erroneously affect a resulting analyte concentration measurement.

Variations in a volume of red blood cells within blood can cause variations in glucose readings measured with disposable electrochemical test strips. Typically, a negative bias (i.e., lower calculated analyte concentration) is observed at high hematocrits, while a positive bias (i.e., higher calculated analyte concentration) is observed at low hematocrits. At high hematocrits, for example, the red blood cells may impede the reaction of enzymes and electrochemical mediators, reduce the rate of chemistry dissolution since there is less plasma volume to solvate the chemical reactants, or slow diffusion of the mediator. These factors can result in a lower than expected glucose reading as less current is produced during the electrochemical process. Conversely, at low hematocrits, fewer red blood cells may affect the electrochemical reaction less than expected, and a higher measured current can result. In addition, the blood sample resistance is also hematocrit dependent, which can affect voltage and/or current measurements.

Several strategies have been used to reduce or avoid hematocrit-based variations on blood glucose readings. For example, biosensors have been configured to measure hematocrit by measuring optical variations after irradiating the blood sample with light, or measuring hematocrit based on a function of sample chamber fill time. In addition, alternating current (AC) impedance methods have also been developed to measure electrochemical signals at frequencies independent of hematocrit. While these methods may be effective, they can increase test strip cost and complexity, and may undesirably increase the time required to determine an accurate glucose measurement.

Another prior hematocrit correction scheme is described in U.S. Pat. No. 6,033,866, hereinafter “the '866 patent.” In that system, a whole blood separation membrane is interposed between the reference electrode and the reagent strip to filter red blood cells from whole blood to enable glucose assay without sample preparation. The membrane can include commercially available membranes, such as PrimeCare, Gelman Cytosep and Nucleopore membranes. The '866 patent also describes coating these membranes to promote wetting and/or to prevent cell lysis, wherein one of the disclosed polymers includes alginic acid. However, merely coating commercial membranes may not completely alleviate the disadvantages of using the commercial membranes. Further, designing and manufacturing sensors with commercial membranes can be complicated and expensive.

As mentioned previously, biosensors may inaccurately measure a particular constituent level in blood due to unwanted affects of certain blood components. For example, the hematocrit level in blood can erroneously affect a resulting analyte concentration measurement. Thus, it may be desirable to provide an alginate hydrogel to reduce hematocrit bias of a body sample. In accordance with an exemplary embodiment of the present invention, a test strip may include an alginate hydrogel substantially comprising an alginate polymer. The alginate hydrogel may at least partially cover an electrode or part of a sample chamber to reduce hematocrit bias during an electrochemical test, as described above, to determine, for example, the concentration of glucose within the sample. For example, a body sample may contain cells, such as erythrocytes that may interfere with the electrochemical test. The hydrogel may act to partially slow or attenuate the migration of such cellular material, or reduce cellular contact with one or more electrodes. Such a reduction in cellular migration may function to improve electrochemical testing by reducing any unwanted signal associated with migrating cellular materials.

### SUMMARY OF THE INVENTION

One embodiment is directed to a biosensor having a sample chamber and an electrode, wherein at least part of the electrode is located in the sample chamber. The biosensor also includes an alginate hydrogel substantially covering a portion of the sample chamber, wherein the alginate hydrogel substantially includes an alginate polymer.

Another embodiment of the invention is directed to a method of manufacturing a biosensor including forming at least part of a sample chamber, and forming an electrode, wherein at least part of the electrode is located in the sample chamber. The method also includes applying an alginate hydrogel to at least partially cover a portion of the sample chamber, wherein the hydrogel substantially includes an alginate polymer.

Another embodiment of the invention is directed to a reel for manufacturing biosensors, including a generally planar base layer with a plurality of at least partially formed sample chambers located thereon, wherein at least part of an electrode can be located in each sample chamber. The reel also includes an alginate hydrogel at least partially covering a portion of each sample chamber, wherein the alginate hydrogel substantially includes an alginate polymer.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1A illustrates test media that can be produced using the methods of the present disclosure.

FIG. 1B illustrates a test meter that can be used with test media produced according to the methods of the present disclosure.

FIG. 1C illustrates a test meter that can be used with test media produced according to the methods of the present disclosure.

FIG. 2 is a top plan view of a test strip according to an exemplary embodiment of the invention.

FIG. 3 is a cross-sectional view of the test strip of FIG. 2, taken along line 3-3.

FIG. 4A is a top view of a reel according to an exemplary disclosed embodiment of the invention.

FIG. 4B is an enlarged tip view of a feature set on the reel of FIG. 4A.

FIG. 5 is a top view of a test card according to a further illustrative embodiment of the invention.

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

A “sample” may include a compositional mixture containing an unknown amount of the analyte (e.g., glucose) of interest. Typically, a sample for electrochemical analysis is in liquid form, and preferably the sample is an aqueous mixture. A sample may be a body sample, such as blood, urine or saliva. A sample may be a derivative of a body sample, such as an extract, a dilution, a filtrate, or a reconstituted precipitate.

An “alginate polymer” may include alginate, alginic acid, algine, E400, or any polymer with a molecular formula (C₆H₈O₆)ₙ. The alginate polymer may have a molecular mass ranging from about 10,000-600,000. In some cases, alginate may be extracted from the cell walls of brown algae.

In some embodiments, alginate may be cross-linked via various chemical reactions. For example, alginate may be cross-linked in the presence of various ions, such as, for example, divalent ions. Divalent ions, including barium, calcium, or strontium ions may crosslink alginate to form a porous structure. In some embodiments, cross-linked alginate may have an average pore size ranging from about 1 micron to about 10 microns.

In other embodiments, an alginate hydrogel may substantially include an alginate polymer. A hydrogel can include a network of polymer chains that are generally water-insoluble, wherein water acts as a dispersion medium. Hydrogels can be super-absorbent natural or synthetic polymers because they can contain over 99% water. Also, hydrogels possess a degree of flexibility very similar to natural tissue, due to their significant water content.

The alginate hydrogel may be at least partially dehydrated or re-hydrated. For example, the alginate hydrogel may be partially dehydrated by air drying the hydrogel to partially remove water from the alginate hydrogel. Following, a sample fluid may be added to the alginate hydrogel, wherein the sample fluid may at least partially re-hydrate the alginate hydrogel. In some embodiments, the addition of the sample fluid may cause the alginate hydrogel to have an average pore size ranging from about 1 micron to about 10 microns.

An alginate hydrogel may reduce cellular migration by attenuating or inhibiting the movement of cellular material onto, or away from, an electrode. Cellular material can include cells, proteins, lipids, nucleic acid, vesicles, and other biological material contained in a sample. In some situations, cellular material may partially cover an electrode surface, reducing an electrode area available for reaction or increasing mediator diffusion time. By reducing or eliminating migration of cellular material, a signal bias due to variation in sample hematocrit can be reduced.

A “mediator” may include a substance that can be oxidized or reduced and that can transfer one or more electrons between a first substance and a second substance. A mediator is a reagent in an electrochemical analysis and is not the analyte of interest. In a simple system, the mediator undergoes a redox reaction with the oxidoreductase after the oxidoreductase has been reduced or oxidized through its contact with an appropriate substrate. This oxidized or reduced mediator then undergoes the opposite reaction at the electrode and is regenerated to its original oxidation number. In some embodiments, a mediator can include an anionic mediator, such as, for example, potassium ferricyanide. In other embodiments, a mediator can be uncharged or can be a monovalent cation.

An “oxidoreductase” may include any enzyme that facilitates the oxidation or reduction of a substrate. Oxidoreductases may include “oxidases,” which facilitate oxidation reactions whereby molecular oxygen is the electron acceptor; “reductases,” which facilitate reduction reactions to reduce the substrate; and “dehydrogenases,” which facilitate oxidation reactions wherein molecular oxygen is not the electron acceptor. See, for example, Oxford Dictionary of Biochemistry and Molecular Biology, Revised Edition, A. D. Smith, Ed., New York: Oxford University Press (1997) pp. 161, 476, 477, and 560, which is herein incorporated by reference in its entirety. Examples of oxidoreductases includes glucose dehydrogenase (GDH), glucose oxidase, lactate oxidase, pyruvate oxidase, alcohol oxidase, uricase, cholesterol oxidase, β-hydroxybutyrate dehydrogenase, alcohol dehydrogenase, pyruvate dehydrogenase, lactate dehydrogenase, glucose-6-phosphate dehydrogenase, glycerol-3-phosphate oxidase, and the like. In one embodiment of the present invention the oxidoreductase is selected from GDH and glucose oxidase.

For purposes of this disclosure, “distal” refers to the portion of a test strip further from the fluid source (i.e., closer to the meter) during normal use, and “proximal” refers to the portion closer to the fluid source (e.g., a finger tip with a drop of blood for a glucose test strip) during normal use. The test strip may include a sample chamber for receiving a user's body sample, such as, for example, a blood sample. The sample chamber and test strip of the present specification can be formed using materials and methods described in commonly owned U.S. Pat. No. 6,743,635, which is hereby incorporated by reference in its entirety. Accordingly, a sample chamber may include a first opening in the proximal end of the test strip and a second opening for venting the sample chamber. The sample chamber may be dimensioned so as to be able to draw the blood sample in through the first opening and to hold the blood sample in the sample chamber by capillary action. The test strip can include a tapered section that is narrowest at the proximal end, or can include other indicia in order to make it easier for the user to locate the first opening and apply the blood sample.

A first set of electrodes, such as a working electrode and a counter electrode, can be disposed in a sample chamber optionally along with one or more fill-detect electrodes. The sample chamber can further include a reagent layer configured to contact at least one of the first set of electrodes, such as, for example, the working electrode. The reagent layer may include an enzyme, such as glucose oxidase or glucose dehydrogenase, and a mediator, such as potassium ferricyanide. In addition, the sample chamber may be configured to permit determination of one or more analytes in a body sample, such as, for example, glucose.

In some embodiments, the sample chamber may include an alginate hydrogel, wherein the alginate hydrogel substantially includes an alginate polymer and can be configured to reduce hematocrit bias. The alginate hydrogel may substantial cover a part of the sample chamber, wherein the alginate hydrogel substantially includes an alginate polymer configured to reduce hematocrit bias.

The test strip has, near its distal end, a plurality of electrical contacts that are electrically connected to the electrodes via conductive traces. In addition, the test strip may also include a second plurality of electrical strip contacts near the distal end of the strip. The second plurality of electrical contacts can be arranged such that they provide, when the strip is inserted into the meter, a distinctly discernable lot code readable by the meter. In some embodiments, the electrical contacts may be at least partially covered with an at least partially conductive material to improve the wear properties of the electrical contacts.

An individual test strip may also include an embedded code relating to data associated with a lot of test strips, or data particular to that individual strip. The embedded information presents data readable by the meter signaling the meter's microprocessor to access and utilize a specific set of stored calibration parameters particular to test strips from a manufacturing lot to which the individual strip belongs, or to an individual test strip. The system may also include a check strip that the user may insert into the meter to check that the instrument is electrically calibrated and functioning properly. The readable code can be read as a signal to access data, such as calibration coefficients, from an on-board memory unit in the meter.

In order to save power, the meter may be battery powered and may stay in a low-power sleep mode when not in use. When the test strip is inserted into the meter, one or more electrical contacts on the test strip form electrical connections with one or more corresponding electrical contacts in the meter. The second plurality of electrical contacts may bridge a pair of electrical contacts in the meter, causing a current to flow through a portion of the second plurality of electrical contacts. The current flow through the second plurality of electrical contacts causes the meter to wake up and enter an active mode. The meter also reads the code information provided by the second plurality and can then identify, for example, the particular test to be performed or a confirmation of proper operating status. Calibration data pertaining to strip lot, analyte testing, hematocrit, or other parameters, can also be encoded or otherwise represented. In addition, based on the particular code information, the meter can also identify the inserted strip as either a test strip or a check strip. If the meter detects a check strip, it performs a check strip sequence. If the meter detects a test strip, it performs a test strip sequence.

In the test strip sequence, the meter validates the working electrode, counter electrode, and, if included, the fill-detect electrodes, by confirming that there are no low-impedance paths between any of these electrodes. If the electrodes are valid, the meter indicates to the user that a sample may be applied to the test strip. The meter then applies a drop-detect voltage between any two suitable electrodes and detects a fluid sample, such as, a body sample, by detecting a current flow between the working and counter electrodes (i.e., a current flow through the body sample as it bridges the working and counter electrodes). To detect if an adequate volume of body sample is present in the sample chamber, the meter may apply a fill-detect voltage to the one or more fill-detect electrodes and measure any resulting current flow. Adequate volume may be required to ensure that sufficient sample volume has traversed the reagent layer, hydrated an alginate hydrogel, and/or mixed with the chemical constituents in the reagent layer. If a resulting electrical property reaches a sufficient level within a predetermined period of time, the meter notify a user that adequate sample has been loaded on a test strip.

The meter can be programmed to wait for a predetermined period of time after initially detecting the body sample to allow the body sample to react with the reagent layer. Alternatively, the meter may be configured to immediately begin taking readings in sequence. During an exemplary fluid measurement sequence using amperometry, the meter applies an assay voltage between two electrodes and takes one or more measurements of the resulting current flowing between the working and counter electrodes. The assay voltage is near the redox potential of the chemistry in the reagent layer, and the resulting current is related to the concentration of the particular constituent measured, such as, for example, the glucose level in a body sample. Voltammetry and coulometry approaches, as known in the art, could also be employed. The meter can calculate the glucose level based on the measured current from the sample chamber. This data, along with calibration data, contained within the test strip may permit the meter to determine a glucose level and display the calculated glucose level to the user.

In some embodiments, the sample chamber of the biosensor can also include an alginate polymer configured to reduce cellular migration. As previously explained, the alginate polymer may form an alginate hydrogel, wherein the alginate hydrogel substantially includes alginate polymer. In some embodiments, the alginate hydrogel may be cross-linked using divalent ions, such as, barium, calcium, or strontium ions. Such a structure may function to at least partially reduce the migration of cellular material contained within a sample into the measurement area, to reduce a signal bias.

Further, the sample chamber can be dimensioned and configured to draw a body sample into the sample chamber via capillary action. The sample chamber may also include one or more alginate hydrogels positioned or configured to reduce cellular migration. For example, a hydrogel may substantially cover an electrode or may substantially cover part of the sample chamber. In particular, the hydrogel may at least partially cover a cross-sectional area of the sample chamber, whereby the hydrogel may extend from the cover to the base layer of the sample chamber. Also, the hydrogel may at least partially extend across an entrance of the sample chamber, or fill the sample chamber. Further, the hydrogel configuration or composition can be optimized to provide analyte determination with reduced cellular migration for a range of different samples or operating conditions.

In some embodiments, the sample chamber may be configured to receive a control solution. The control solution may be used to periodically test one or more functions of a meter. For example, a control solution may include a solution of known electrical properties and an electrical measurement of the solution may be performed by the meter. The control solution may contain a known hematocrit value, or be another solution configured to test or calibrate the operation of a biosensor to ensure proper functioning of a hydrogel.

When the meter detects the use of a control solution, it can provide an operational check of the test strip or meter's functionality to verify the systems measurement integrity. The meter read-out may then be compared to the known glucose value of the solution to confirm that the meter is functioning to an appropriate accuracy. In addition, data associated with a measurement of a control solution may be processed, stored and/or displayed using a meter differently to any data associated with a glucose measurement. Such different treatment of data associated with the control solution may permit a meter, or user, to distinguish a glucose measurement, or may permit exclusion of any control measurements when conducting any statistical analysis of glucose measurements.

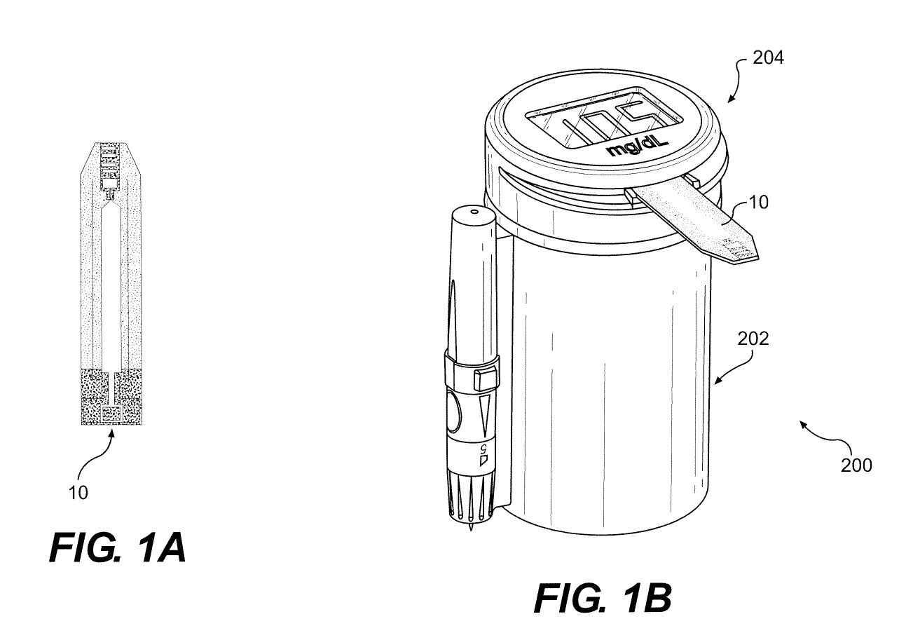

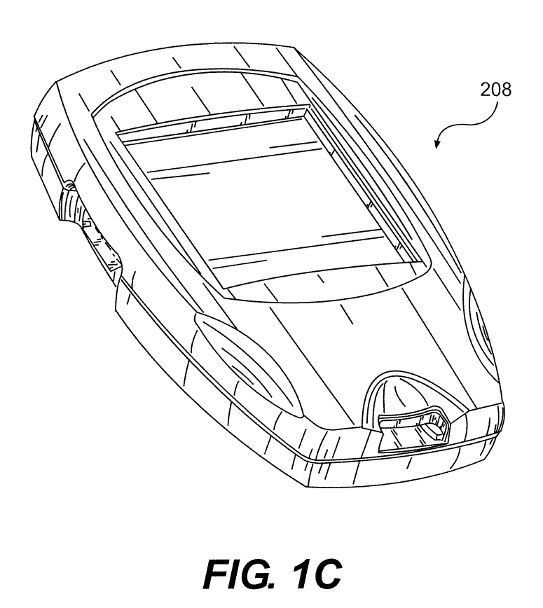

The present disclosure provides a method for producing a diagnostic test strip 10, as shown in FIG. 1A. Test strip 10 of the present disclosure may be used with a suitable test meter 200, 208, as shown in FIGS. 1B and 1C, to detect or measure the concentration of one or more analytes. As shown in FIG. 1A, test strip 10 can be planar and elongated in design. However, test strip 10 may be provided in any suitable form including, for example, ribbons, tubes, tabs, discs, or any other suitable form. Furthermore, test strip 10 can be configured for use with a variety of suitable testing modalities, including electrochemical tests, photochemical tests, electro-chemiluminescent tests, or any other suitable testing modality.

Test meter 200, 208 may be selected from a variety of suitable test meter types. For example, as shown in FIG. 1B, test meter 200 includes a vial 202 configured to store one or more test strips 10. The operative components of test meter 200 may be contained in a meter cap 204. Meter cap 204 may contain electrical meter components, can be packaged with test meter 200, and can be configured to close or seal vial 202. Alternatively, a test meter 208 can include a monitor unit separated from storage vial, as shown in FIG. 1C. Any suitable test meter may be selected to provide a diagnostic test using test strip 10 produced according to the disclosed methods.

### Test Strip Configuration

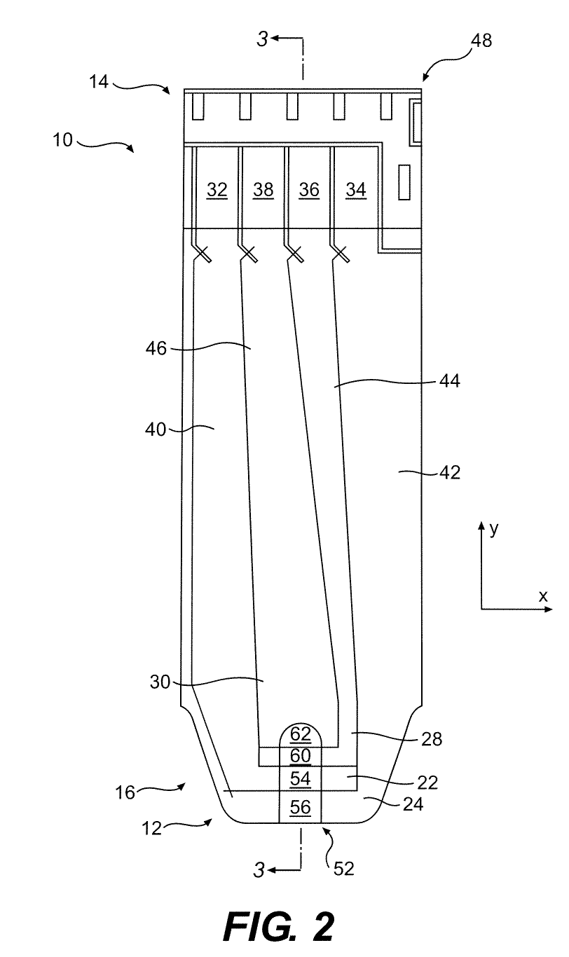

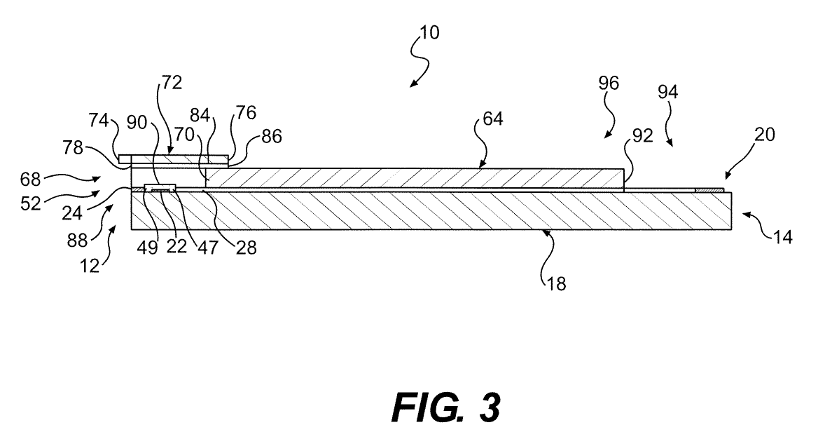

With reference to the drawings, FIGS. 2 and 3 show an exemplary test strip 10, in accordance with an illustrative embodiment of the present invention. Test strip 10 preferably takes the form of a generally flat strip that extends from a proximal end 12 to a distal end 14.

Test strip 10 can be sized for easy handling. For example, test strip 10 can measure approximately 35 mm long (i.e., from proximal end 12 to distal end 14) and approximately 9 mm wide. The strip, however, can be any convenient length and width. For example, a meter with automated test strip handling may utilize a test strip smaller than 9 mm wide. Additionally, proximal end 12 can be narrower than distal end 14 in order to provide facile visual recognition of the distal end. Thus, test strip 10 can include a tapered section 16, in which the full width of test strip 10 tapers down to proximal end 12, making proximal end 12 narrower than distal end 14.

As described in more detail below, the user applies a body sample to an opening in proximal end 12 of test strip 10. Thus, providing tapered section 16 in test strip 10, and making proximal end 12 narrower than distal end 14, assists the user in locating the opening where the body sample is to be applied. Further, other visual means, such as indicia, notches, contours or the like are possible.

As shown in FIG. 3, test strip 10 can have a generally layered construction. Working upwardly from the bottom layer, test strip 10 can include a base layer 18 extending along the entire length of test strip 10. Base layer 18 can be formed from an electrically insulating material and has a thickness sufficient to provide structural support to test strip 10. For example, base layer 18 can be a polyester material about 0.35 mm thick.

According to the illustrative embodiment, a conductive layer 20 is disposed on base layer 18. Conductive layer 20 includes a plurality of electrodes disposed on base layer 18 near proximal end 12, a plurality of electrical contacts disposed on base layer 18 near distal end 14, and a plurality of conductive regions electrically connecting the electrodes to the electrical contacts. In the illustrative embodiment depicted in FIG. 2, the plurality of electrodes includes a working electrode 22, a counter electrode 24, and fill-detect electrodes 28, 30.

The electrical contacts can correspondingly include a working electrode contact 32, a counter electrode contact 34, and fill-detect electrode contacts 36, 38. The conductive regions can include a working electrode conductive region 40, electrically connecting working electrode 22 to working electrode contact 32, a counter electrode conductive region 42, electrically connecting counter electrode 24 to counter electrode contact 36, a fill-detect electrode conductive region 44 electrically connecting fill-detect electrode 28 to fill-detect contact 36, and a fill-detect electrode conductive region 46 electrically connecting fill-detect electrode 30 to fill-detect contact 38. Further, the illustrative embodiment is depicted with conductive layer 20 including an auto-on conductor 48 disposed on base layer 18 near distal end 14.

In addition, the present disclosure provides test strips 10 that include electrical contacts that are resistant to scratching or abrasion. Such test strips 10 can include conductive electrical contacts formed of two or more layers of conductive or semi-conductive material. A first lower conductive layer 20 can include a conductive metal, ink, or paste. A second upper layer (not illustrated) can include a conductive ink or paste. Further, in some embodiments, the upper layer can have a resistance to abrasion that is greater than the lower layer. In addition, the second upper layer may have a thickness such that, even when scratched or abraded, the entire thickness of the conductive layer will not be removed, and the electrical contact will continue to function properly. Thus, such test strips 10 can include electrical contacts having material properties and dimensions such that, even when scratched or abraded, the test strips will continue to function properly. Further information relating to electrical contacts that are resistant to scratching or abrasion are described in U.S. patent application Ser. No. 11/458,298 which is incorporated by reference herein in its entirety.

The next layer in the illustrative test strip 10 is a dielectric spacer layer 64 disposed on conductive layer 20. Dielectric spacer layer 64 is composed of an electrically insulating material, such as polyester. Dielectric spacer layer 64 can be about 0.100 mm thick and covers portions of working electrode 22, counter electrode 24, fill-detect electrodes 28, 30, and conductive regions 40-46, but in the illustrative embodiment does not cover electrical contacts 32-38 or auto-on conductor 48. For example, dielectric spacer layer 64 can cover substantially all of conductive layer 20 thereon, from a line just proximal of contacts 32 and 34 all the way to proximal end 12, except for a sample chamber 52. In this way, sample chamber 52 can define an exposed portion 54 of working electrode 22, an exposed portion 56 of counter electrode 24, an exposed portion 60 of fill-detect electrode 28, and an exposed portion 62 of fill-detect electrode 30. In some embodiments, sample chamber 52 may be configured to detect an analyte concentration in a body sample. The shape of sample chamber 52 may be achieved prior to application on the base layer.

A cover 72, having a proximal end 74 and a distal end 76, can be attached to dielectric spacer layer 64 via an adhesive layer 78. Cover 72 can be composed of an electrically insulating material, such as polyester, and can have a thickness of about 0.1 mm. Additionally, the cover 72 can be transparent.

Adhesive layer 78 can include a polyacrylic or other adhesive and have a thickness of about 0.013 mm. Adhesive layer 78 can consist of sections disposed on spacer 64 on opposite sides of sample chamber 52. A break 84 in adhesive layer 78 extends from distal end 70 of sample chamber 52 to an opening 86. Cover 72 can be disposed on adhesive layer 78 such that its proximal end 74 is aligned with proximal end 12 and its distal end 76 is aligned with opening 86. In this way, cover 72 covers sample chamber 52 and break 84.

Proximal end 74 of cover 72 can extend from distal end 70 beyond proximal end 12 to create an overhang, as shown in FIG. 3. The overhang may be formed by extending cover 72 beyond proximal end 12 or by removing at least part of base layer 18 or other appropriate material under cover 72 to create a notch or similar structure. This overhang/notch configuration can aid in forming a hanging reservoir for a body sample, via surface tension, to aid in providing a sufficient sample into sample chamber 52. It is also contemplated that various materials, surface coatings (e.g. hydrophilic and/or hydrophobic), or other structure protrusions and/or indentations at proximal end 12 may be used to form a suitable body sample reservoir.

Proximal end 68 of sample chamber 52 defines a first opening in sample chamber 52, through which the body sample is introduced into sample chamber 52. At distal end 70 of sample chamber 52, break 84 defines a second opening in sample chamber 52, for venting sample chamber 52 as a fluid sample enters sample chamber 52. Sample chamber 52 can be dimensioned such that a body sample applied to its proximal end 68 is drawn into sample chamber 52 by capillary action, with break 84 venting sample chamber 52 through opening 86, as the body sample enters. Moreover, sample chamber 52 can advantageously be dimensioned so that the body sample that enters sample chamber 52 by capillary action is about 1 micro-liter or less. For example, sample chamber 52 can have a length (i.e., from proximal end 12 to distal end 70) of about 0.140 inches, a width of about 0.060 inches, and a height (which can be substantially defined by the thickness of dielectric spacer layer 64) of about 0.005 inches. Other dimensions could be used, however.

As shown in FIG. 3, a reagent layer 90 can be disposed in sample chamber 52, wherein reagent layer 90 may include one or more chemical constituents to enable the level of glucose in the body sample to be determined electrochemically. Thus, reagent layer 90 may include an enzyme specific for an analyte and a mediator, as described above. In addition, reagent layer 90 may also include other components, buffering materials (e.g., potassium phosphate), polymeric binders (e.g., hydroxypropylmethyl-cellulose, sodium alginate, microcrystalline cellulose, polyethylene oxide, hydroxyethylcellulose, and/or polyvinyl alcohol), and surfactants (e.g., Triton X-100 or Surfynol 485).

In some embodiments, reagent layer 90 can include an alginate hydrogel, wherein the alginate hydrogel can substantially include an alginate polymer. The alginate hydrogel can be formed as described below. Further, divalent ions can be added to cross link the alginate polymer to form an appropriate hydrogel structure. Various ions, including, barium, calcium, or strontium ions may be added to affect pore size of the hydrogel, or other chemical or structural properties of the alginate hydrogel. For example, the alginate hydrogel may include an average pore size ranging from about 1 micron to about 10 microns.

In other embodiments, an alginate hydrogel can be formed to cover a portion of sample chamber 52, such as, for example, at least part of an electrode within sample chamber 52 or a cross-sectional area of sample chamber 52. Alternatively, a hydrogel could be formed to substantially cover an entrance of sample chamber 52, or to fill sample chamber 52. These and other embodiments may be used to form an alginate hydrogel that operates to reduce the migration of components of a body sample loaded into sample chamber 52. Such a hydrogel may function to reduce cellular migration within sample chamber 52, or reduce contact of cellular material to one or more electrodes in sample chamber 52, such as, for example, working electrode 22 or counter electrode 24.

As depicted in FIG. 3, the arrangement of the various layers in illustrative test strip 10 can result in test strip 10 having different thicknesses in different sections. In particular, among the layers above base layer 18, much of the thickness of test strip 10 can come from the thickness of spacer 64. Thus, the edge of spacer 64 that is closest to distal end 14 can define a shoulder 92 in test strip 10. Shoulder 92 can define a thin section 94 of test strip 10, extending between shoulder 92 and distal end 14, and a thick section 96, extending between shoulder 92 and proximal end 12. The elements of test strip 10 used to electrically connect it to the meter, namely, electrical contacts 32-38 and auto-on conductor 48, can all be located in thin section 94. Accordingly, the connector in the meter can be sized and configured to receive thin section 94 but not thick section 96, as described in more detail below. This can beneficially cue the user to insert the correct end, i.e., distal end 14 in thin section 94, and can prevent the user from inserting the wrong end, i.e., proximal end 12 in thick section 96, into the meter. Although FIGS. 2 and 3 illustrate an illustrative embodiment of test strip 10, other configurations, chemical compositions and electrode arrangements could be used.

### Test Strip Array Configuration

Test strips can be manufactured by forming a plurality of strips in an array along a reel or web of substrate material. The term “reel” or “web” as used herein applies to continuous webs of indeterminate length, or to sheets of determinate length. The individual strips, after being formed, can be separated during later stages of manufacturing. An illustrative embodiment of a batch process of this type is described infra. First, an illustrative test strip array configuration is described.

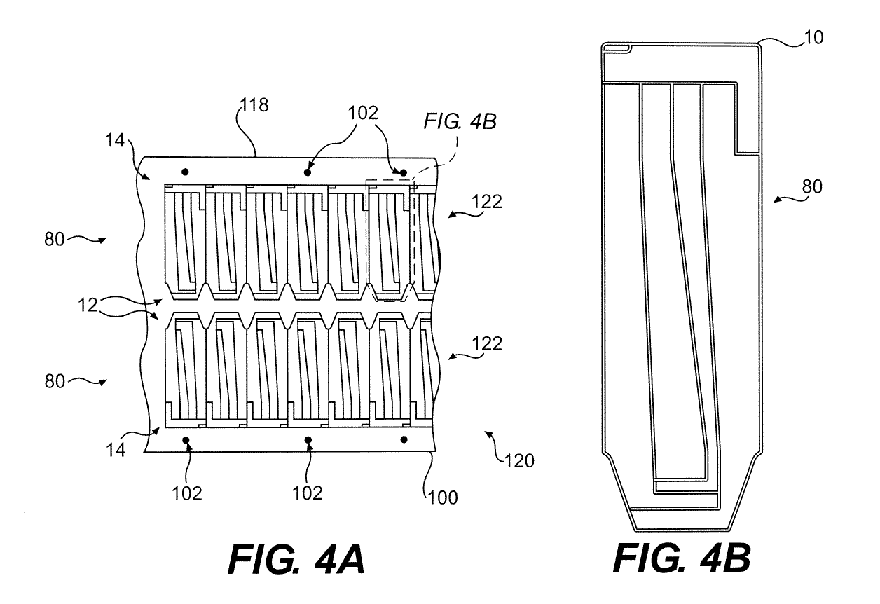

FIG. 4A shows a series of traces 80 formed in a substrate material coated with a conductive layer. Trace 80, formed in the exemplary embodiment by laser ablation, partially form the conductive layers of two rows of test strips as shown. In the exemplary embodiment depicted, proximal ends 12 of the two rows of test strips are in juxtaposition in the center of a reel 100. The distal ends 14 of the test strips are arranged at the periphery of reel 100. It is also contemplated that the proximal ends 12 and distal ends 14 of the test strips can be arranged in the center of reel 100. Alternatively, the two distal ends 14 of the test strips can be arranged in the center of reel 100. The lateral spacing of the test strips is designed to allow a single cut to separate two adjacent test strips. The separation of the test strip from reel 100 can electrically isolate one or more conductive components of the separated test strip 10.

As depicted in FIG. 4A, trace 80 for an individual test strip forms a plurality of conductive components; e.g., electrodes, conduction regions and electrode contacts. Trace 80 is comprised of individual cuts made by a laser following a specific trajectory, or vector. A vector can be linear or curvilinear, and define spaces between conductive components that are electrically isolating. Generally a vector is a continuous cut made by the laser beam.

The conductive components can be partially or entirely defined by ablated regions, or laser vectors, formed in the conductive layer. The vectors may only partially electrically isolate the conductive component, as the component can remain electrically connected to other components following laser ablation. The electrical isolation of the conductive components can be achieved following “singulation,” when individual test strips are separated from reel or web 100. It is also contemplated that other conductive components may be electrically isolated during the laser ablation process. For example, fill detect electrodes may be isolated with the addition of one or more vectors.

FIG. 4A also includes registration points 102 at the distal end 14 of each test strip on reel 100. Registration points 102 assist the alignment of the layers during the lamination, punching and other manufacturing processes. It is further contemplated that registration points 102 may be located at locations other than the distal end 14 of each test strip trace 80 on reel 100. High quality manufacturing may require additional registration points 102 to ensure adequate alignment of laminate layers and/or other manufacturing processes, such as, for example, laser ablation of conductive components, reagent deposition, singulation, etc.

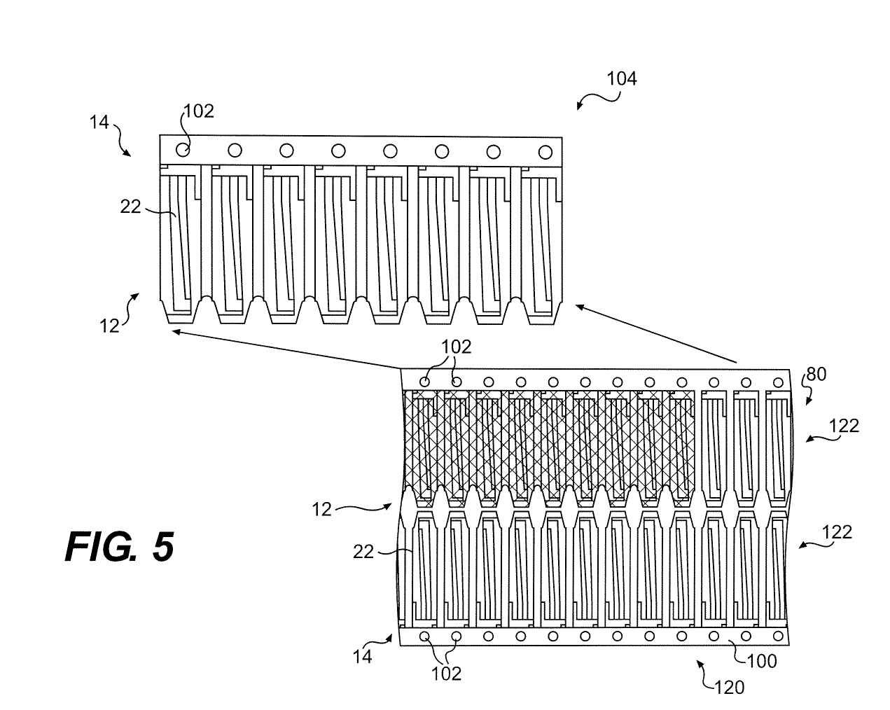

FIG. 5 shows a “test card” 104 separated from reel 100. Test card 104 can contain a plurality of test strips 10 or traces 80, and a plurality of conductive components. In some embodiments, test card 104 can contain between 6 and 12 test strips 10 or traces 80. In other embodiments, test card 104 can contain a plurality of test strips 10 or traces 80. In the illustrated embodiment, test card 104 can include a lateral array of test strips 10 or traces 80. In other embodiments, test card 104 can include an array or arrays of test strips 10 or traces 80 in longitudinal or lateral configurations. It is further contemplated that test strips 10 or traces 80 may be in any arrangement on reel 100 suitable for manufacturing.

Test card 104 contains a plurality of conductive components. Some conductive components can be electrically isolated when the test card is removed from the reel. As shown in FIG. 5, working electrode 22 is electrically isolated. Other embodiments could include additional electrically isolated conductive components not shown in FIG. 5. It may be possible to analyze properties of the electrically isolated conductive components to assess the quality of the manufacturing process. The efficiency of the quality assessment process can be increased by testing at least one of the plurality of electrically isolated conductive components.

### Batch Manufacturing of Test Strips

Test strip 10 may be manufactured using any suitable manufacturing methods. For example, one or more conductive components may be manufactured using laser ablation employing projected masks or raster scanning methods, screen printing, insert injection molding, and any other suitable techniques. One of more sample chambers, or capillaries, may be formed using a spacer, dielectric build-up, injection molded, laser ablation, or other suitable method. One illustrative embodiment for manufacturing test strip 10 will now be described in detail.

FIGS. 4A through 5 illustrate an exemplary method of manufacturing test strips. Although these figures shows steps for manufacturing test strip 10, as shown in FIGS. 4A through 5, it is to be understood that similar steps can be used to manufacture test strips having other configurations.

With reference to FIG. 4A, a plurality of test strips 10 can be produced by forming a structure 120 that includes a plurality of test strip traces 122 on reel 100. Test strip traces 122 include a plurality of traces 80, and can be arranged in one or more rows.

FIGS. 4A and 4B show only one test strip structure (either partially or completely fabricated), in order to illustrate various steps in an exemplary method for forming the test strip structures 122. In this approach, the test strip structures 122 in integrated structure 120 are all formed on a sheet of material that serves as base layer 18 in the finished test strips 10. The other components in the finished test strips 10 are then built up layer-by-layer on top of base layer 18 to form the test strip structures 122. In each of FIGS. 4A and 4B, the outer shape of the test strip 10 that would be formed in the overall manufacturing process is shown as a dotted line.

The exemplary manufacturing process employs base layer 18 covered by conductive layer 20. Conductive layer 20 and base layer 18 can be in the form of a reel, ribbon, continuous web, sheet, or other similar structure. Conductive layer 20 can include any suitable conductive or semi-conductor material, such as gold, silver, palladium, carbon, tin oxide and others known in the art. Conductive layer 20 can be formed by sputtering, vapor deposition, screen printing or any suitable manufacturing method. For example, one or more electrodes may be at least partially formed by sputtering, evaporation, electroplating, ultrasonic spraying, pressure spraying, direct writing, shadow mask lithography, lift-off lithography, or laser ablation. Also, the conductive material can be any suitable thickness and can be bonded to base layer 18 by any suitable means.

As shown in FIG. 2, conductive layer 20 can include working electrode 22, counter electrode 24, and fill-detect electrodes 28, 30. Trace 80 can be formed by laser ablation where laser ablation can include any device suitable for removal of the conductive layer in appropriate time and with appropriate precision and accuracy. Various types of lasers can be used for sensor fabrication, such as, for example, solid-state lasers (e.g. Nd:YAG and titanium sapphire), copper vapor lasers, diode lasers, carbon dioxide lasers and excimer lasers. Such lasers may be capable of generating a variety of wavelengths in the ultraviolet, visible and infrared regions. For example, excimer laser provides wavelength of 248 nm, a fundamental Nd:YAG laser gives 1064 nm, a frequency tripled Nd:YAG wavelength is at 355 nm and a Ti:sapphire laser is at approximately 800 nm. The power output of these lasers may vary and is usually in range 10-100 watts.

The laser ablation process can include a laser system. The laser system can include a laser source. The laser system can further include means to define trace 80, such as, for example, a focused beam, projected mask or other suitable technique. The use of a focused laser beam can include a device capable of rapid and accurate controlled movement to move the focused laser beam relative to conductive layer 20. The use of a mask can involve a laser beam passing through the mask to selectively ablate specific regions of conductive layer 20. A single mask can define test strip trace 80, or multiple masks may be required to form test strip trace 80. To form trace 80, the laser system can move relative to conductive layer 20. Specifically, the laser system, conductive layer 20, or both the laser system and conductive layer 20 may move to allow formation trace 80 by laser ablation. Exemplary devices available for such ablation techniques include Microline Laser system available from LPKF Laser Electronic GmbH (Garbsen, Germany) and laser micro machining systems from Exitech, Ltd (Oxford, United Kingdom).

In some embodiments, laser ablation of the conductive layer may not electrically isolate certain conductive components. The separation process can also be used to electrically isolate conductive components of test strip 10. The non-isolated conductive components may be isolated by the separation process whereby test strips are separated from reel 100. The separation process may sever the electrical connection, isolating the conductive component. Separating test strip 10 can electrically isolate the counter electrode 24, fill detect-anode 28, and fill-detect cathode 30. The separation process can complete the electrical isolation of conductive components by selectively separating conductive components.

Further, the separation process can provide some or all of the shape of the perimeter of the test strips 10. For example, the tapered shape of tapered sections 16 of the test strips 10 can be formed during this punching process. Next, a slitting process can be used to separate the test strip structures 122 into individual test strips 10. The separation process may include stamping, slitting, scoring and breaking, or any suitable method to separate test strip 10 and/or card 104 from reel 100.

In the next step, dielectric spacer layer 64 can be applied to conductive layer 20, as illustrated in FIG. 3. Spacer 64 can be applied to conductive layer 20 in a number of different ways. In an exemplary approach, spacer 64 is provided as a sheet or web large enough and appropriately shaped to cover multiple test strip traces 80. In this approach, the underside of spacer 64 can be coated with an adhesive to facilitate attachment to conductive layer 20. Portions of the upper surface of spacer 64 can also be coated with an adhesive in order to provide adhesive layer 78 in each of the test strips 10. Various sample chambers can be cut, formed or punched out of spacer 64 to shape it before, during or after the application of spacer layer 64 to conductive layer 20. In addition, spacer 64 can include adhesive sections 66, with break 84 there between, for each test strip trace 80. Spacer 64 is then positioned over conductive layer 20, as shown in FIG. 3, and laminated to conductive layer 20. When spacer 64 is appropriately positioned on conductive layer 20, exposed electrode portions 54-62 are accessible through sample chamber 52. Similarly, spacer 64 leaves contacts 32-38 and auto-on conductor 48 exposed after lamination.

Alternatively, spacer 64 could be applied in other ways. For example, spacer 64 can be injection molded onto base layer 18. Spacer 64 could also be built up on base layer 18 by screen-printing successive layers of a dielectric material to an appropriate thickness, e.g., about 0.005 inches. An exemplary dielectric material can include a mixture of silicone and acrylic compounds, such as the “Membrane Switch Composition 5018” available from E.I. DuPont de Nemours & Co., Wilmington, Del. Other materials could be used, however.

Additionally, sample chambers can be formed after application of the spacer 64 on top of base layer 18 and conductive layer 20 via the aforementioned laser ablation process. This process allows for the removal of the conductive layer within sample chambers.

Reagent layer 90 can then be applied to each test strip structure. In an illustrative approach, reagent layer 90 can be applied by dispensing a formulation onto exposed portion 54 of working electrode 22 and lefting it dry to form reagent layer 90. Alternatively, other methods, such as screen-printing, spray deposition, piezo and ink jet printing, can be used to apply the composition used to form reagent layer 90.

In some embodiments, various constituents may be added to reagent layer 90 to at least partially reduce a hematocrit bias of any measurement. For example, various polymers, molecules, and/or compounds may be added to reagent layer 90 to reduce cell migration and hence may increase the accuracy of a measurement based on an electrochemical reaction. In some embodiments, reagent layer 90 can include an alginate hydrogel substantially including an alginate polymer configured to reduce cellular migration. As previously described, such a hydrogel can be configured to cover at least part of one electrode within sample chamber 52, or part of sample chamber 52. In other embodiments, an alginate hydrogel can be formed separately from reagent layer 90. Such a hydrogel could be formed to contact reagent layer 90, or not contact reagent layer 90. Further, such a hydrogel could be formed before or after reagent layer 90.

An exemplary formulation can contain 50-100 mM potassium phosphate, pH 4.2-5.1, 100-125 mM potassium ferricyanide, 3,750-5,000 U/mL glucose oxidase, 0.05-0.15% Triton X-100, and 0.25%-2.0% alginate. Another exemplary formulation can contain 50-100 mM TES buffer, pH 7.0-7.5, 100-125 mM potassium ferricyanide, 3,750-5,000 U/mL glucose oxidase, 0.05-0.15% Triton X-100, and 0.25%-2.0% alginate. In some embodiments, 1% alginate can be used. Also, sodium citrate or sodium acetate can be substituted for potassium phosphate, and MOPS or HEPES buffer can be substituted for TES buffer. Such formulations may not require a divalent cation as an alginate acid gel may form. Generally, the pH range of a reconstituted reagent layer 90 can be between about 5 to about 10.

Constituents of reagent layer 90 may be combined and deposited on test strip 10. The resulting hydrogel may then be partially dehydrated as required for long term storage. Dehydration may include air-drying, pressure reduction, using desiccant, or any other method known in the art. A partially dehydrated hydrogel may be re-hydrated when contacted with a fluid body sample. Such hydration may form a hydrogel containing pore sizes ranging from about 1 micron to about 10 microns. In other embodiments, a hydrogel may have smaller pore sizes, such as, for example, 0.1 micron. In yet other embodiments, a hydrogel may have larger pore sizes, such as, for example, 20, 50, or 100 microns.

To illustrate a deposition process by way of example, about 1.0 to 1.40 μL of an above formulation can be dispensed onto test strip 10 and allowed to dry at a temperature between about 22 and 56° C. Then, an approximately equal volume of a solution of 5-80 mmol/L of a divalent cation, such as, calcium, strontium, or barium, can be added to test strip 10 containing the previously dried formulation. This second solution, or gelling solution, can be further dried at a temperature between about 22 and 56° C. Generally, the gelling cation can affect the hydrogel structure and/or formation kinetics.

In some situations, it may be necessary to slow a cross-linking reaction associated with the formation of the hydrogel. For example, inhibitory (binding) anions may be added to a formulation prior to dispensing the formulation on test strip 10, to generally slow cation and alginate binding. Such anions can include phosphate, carbonate, or citrate ions at concentrations up to about 100 mmol/L. Another example could include adding inhibitory cations, such as, magnesium, sodium, or potassium ions, to a formulation, a gelling solution, or both. These inhibitory cations may compete with the gelling cations for alginate binding, but may not “gel” the alginate. Magnesium can be added at concentrations ranging from about 5 to 200 mmol/L, and sodium and potassium at concentrations ranging from about 50 to 900 mmol/L. A further example could include mixing smaller amounts of gelling cation, such as, for example, less than about 3 mmol/L, with a formulation prior to drying. Such a mixture may generally exhibit limited gelling following mixing, but may exhibit increased gelling as the formulation dries because of increasing alginate and cation concentration. Such a method of preparation could be performed in a single step and may be conducted at neutral pH.

A transparent cover 72 can then be attached to adhesive layer 78. Cover 72 may be large enough to cover multiple test strip structures 122. Attaching cover 72 can complete the formation of the plurality of test strip structures 122. The plurality of test strip structures 122 can then be separated from each other to form a plurality of test strips 10, as described above.

While various test strip structures and manufacturing methods are described above, they are not intended to be limiting of the claimed invention. Unless expressly noted, the particular test strip structures and manufacturing methods are listed merely as examples and are not intended to be limiting of the invention as claimed. Other embodiments of the invention will be apparent to those skilled in the art from consideration of the specification and practice of the invention disclosed herein.

What is claimed is:

1. A biosensor, comprising:
a sample chamber;
an electrode, wherein at least part of the electrode is located in the sample chamber; and
an alginate hydrogel substantially covering a portion of the sample chamber, wherein the alginate hydrogel substantially comprises an alginate polymer.

2. The biosensor of claim 1, wherein the alginate hydrogel covers at least part of the electrode.

3. The biosensor of claim 1, wherein the alginate hydrogel is at least partially cross-linked.

4. The biosensor of claim 3, wherein the alginate hydrogel includes a divalent ion.

5. The biosensor of claim 4, wherein the divalent ion includes at least one of a barium ion, a calcium ion, and a strontium ion.

6. The biosensor of claim 3, wherein the alginate hydrogel includes an average pore size ranging from about 1 micron to about 10 microns.

7. The biosensor of claim 1, wherein the biosensor includes at least one of a mediator, and an oxidoreductase.

8. The biosensor of claim 7, wherein the mediator includes potassium ferricyanide.

9. The biosensor of claim 7, wherein the oxidoreductase includes at least one of glucose dehydrogenase, and glucose oxidase.

10. An analyte testing system, comprising:
a meter system for making a measurement of an analyte concentration in a body sample, wherein the meter system is configured to use the biosensor of claim 1.

11. A method of manufacturing a biosensor, comprising:
forming at least part of a sample chamber;
forming an electrode, wherein at least part of the electrode is located in the sample chamber; and
applying an alginate hydrogel to at least partially cover a portion of the sample chamber, wherein the hydrogel substantially comprises an alginate polymer.

12. The method of claim 11, wherein the alginate hydrogel covers at least part of the electrode.

13. The method of claim 11, further comprising the step of at least partially cross-linking the alginate hydrogel.

14. The method of claim 13, wherein the step of cross-linking further comprises providing a divalent ion.

15. The method of claim 14, wherein the divalent ion includes at least one of a barium ion, a calcium ion, and a strontium ion.

16. The method of claim 11, further comprising the step of applying to the sample chamber at least one of a mediator, and an oxidoreductase.

17. The method of claim 16, wherein the step of applying the mediator further comprises applying potassium ferricyanide.

18. The method of claim 16, wherein the step of applying the oxidoreductase further comprises applying at least one of glucose dehydrogenase, and glucose oxidase.

19. The method of claim 11, wherein the step of applying the alginate hydrogel comprises a process selected from the group consisting of screen-printing, spray deposition, piezo printing, pipetting, and ink jet printing.

20. A reel for manufacturing biosensors, comprising:
a generally planar base layer including a plurality of at least partially formed sample chambers located thereon, wherein at least part of an electrode is located in each sample chamber; and
an alginate hydrogel at least partially covering a portion of each sample chamber, wherein the alginate hydrogel substantially comprises an alginate polymer.

21. The reel of claim 20, further including a plurality of registration points formed on the generally planar base layer.

22. The reel of claim 21, wherein the plurality of registration points are formed by a process selected from the group consisting of laser ablation, etching, drilling, printing, punching, scoring, heating, compression and molding.

23. The reel of claim 20, wherein the alginate hydrogel covers at least part of the electrode.

24. The reel of claim 20, wherein the alginate hydrogel is at least partially cross-linked.

25. The reel of claim 24, wherein the alginate hydrogel includes a divalent ion.

26. The reel of claim 25, wherein the divalent ion includes at least one of a barium ion, a calcium ion, and a strontium ion.

27. The reel of claim 24, wherein the alginate hydrogel includes an average pore size ranging from about 1 micron to about 10 microns.

28. The reel of claim 20, wherein each sample chamber includes at least one of a mediator, and an oxidoreductase.

29. The reel of claim 28, wherein the mediator includes potassium ferricyanide.

30. The reel of claim 28, wherein the oxidoreductase includes at least one of glucose dehydrogenase, and glucose oxidase.
